(19) United States
(12) Patent Application Publication
(10) Pub. No.: US 2011/0251757 A1
(43) Pub. Date: Oct. 13, 2011

(54) Electronic Circuit Arrangement with one or more semiconductor main relays and use thereof

(75) Inventors: Wolfgang Fey, Niedernhausen (DE); Heinz Micha, Darmstadt (DE); Timo Dietz, Hochheim (DE); Wolfgang Jöckel, Obertshausen (DE); Lars Lucius, Bad Homburg (DE)

(73) Assignee: Continental Teves AG & Co. oHG

(21) Appl. No.: 12/092,105

(22) PCT Filed: Oct. 30, 2006
(86) PCT No.: PCT/EP2006/067931

§ 371 Date: Apr. 30, 2008

(30) Foreign Application Priority Data
Oct. 31, 2005 (DE) 10 2005 052 405.2
Oct. 30, 2006 (DE) 10 2006 051 722.9

(51) Int. Cl. G05F 1/00; G06F 19/00; B60G 17/015

(52) U.S. Cl. 701/37; 323/265; 701/45

(57) ABSTRACT

Electronic circuit arrangement (5) with one or more semiconductor main relays (1) being connected to at least one semiconductor driver stage (3) for the actuation of loads (4), in which case the semiconductor main relay (1) connects the loads and the drivers to a voltage supply so that they can be disabled, and the semiconductor main relay(s) is (are) operated as a voltage controller in selected situations and as a semiconductor switch in the other situations.

In addition, the invention relates to the use of the above circuit arrangement in a motor vehicle brake system, in particular in a driving dynamics control system, or a system for chassis control or in an electronic actuation unit for vehicle safety systems.

### BACKGROUND OF THE INVENTION

The present invention relates to an electronic circuit arrangement as well as the use thereof in a motor vehicle brake system, in particular a driving dynamics control system, or a system for chassis control or in an electronic actuation unit for vehicle safety systems.

Depending on the equipment with accessories and with sensors, modern electronic brake control systems for motor vehicles, in addition to the lock prevention function ABS, frequently comprise still further safety or comfort functions such as an electronic brake force distribution (EBD), a driving dynamics control function (ESP) or also a collision avoidance system (ACC). These functions are executed centrally in a program-controlled microprocessor system which is part of an electronic circuit arrangement accommodated in the housing of an electronic controller. The electronic controller housing is generally connected directly to a hydraulic block, which among others comprises electrohydraulic hydraulic valves which allow controlling the brake pressure in wheel brake circuits of the motor vehicle. The microprocessor system serves for the electric actuation of the hydraulic valves and the other additional consumers connected to the controller. Typical additional consumers are, for example, a hydraulic pump motor and an actuation control for a brake booster (booster).

The electric driver stages or drivers for the actuation of the above-mentioned loads are connected in per se known brake systems to the voltage supply by way of one joint so-called semiconductor main relay (main driver), which is e.g. realized by a power semiconductor (e.g. Power FET). The semiconductor main relay allows disabling the consumers in the electronic unit with one single switch, for example, when an error appears. Thus, the main relay fulfils an important safety function in the per se know motor vehicle brake control unit described herein.

The problem encountered is that during the period of delivery of a motor vehicle to a wholesale merchant or an end user the case may occur that the above-mentioned electronic control unit mounted into the vehicle is not fed all the time by the usual current supply of the motor vehicle, which is realized by a charged on-board battery and/or a generator, for example. Situations will occur now and then during operation of a motor vehicle in which the current supply of the control unit is connected electrically to external energy stations such as by means of an external starting aid with primitive current generators (so-called ‘jump start’ devices) or like apparatus, and a starting operation is performed. Some vehicle makers even prescribe that the control units are robust with regard to a short-time operation with such simple generators. For protection of the electronics, the control units on which the invention is based are designed in such a way that the electronics will switch off the main relay if the supply voltage is not in compliance with the specification. In addition, the existing safety electronics (watch dog) will adopt a blocked condition which can only be removed by a complete reset. As a result, it is no longer possible that the control unit carries out its controlling functions (e.g. ABS or ESP). A blocked condition of this type can occur above all when excess voltages of the current supply (e.g. disconnection of the battery) appear, which are referred to as ‘load dump transients’.

The invention at topic has for its object to disclose a circuit arrangement with driver stages for loads, which does not react to the above excessive fluctuations of the current supply with a complete interruption of the current supply.

### SUMMARY OF THE INVENTION

This object is achieved according to the invention by an electrionic circuit arrangement (5) with one or more semiconductor main relays (1) being connected to at least one semiconductor driver stage (3) for the actuation of loads (4), in which case the semiconductor main relay (1) connects the loads and the drivers to a voltage supply so that they can be disabled. The semiconductor main relay(s) is (are) operated as a voltage controller in selected situations and as a semiconductor switch in the other situations.

The circuit arrangement of the invention represents an improvement of a per se known actuating circuit for the joint energy actuation of semiconductor driver stages. The driver stages are preferably grouped in one common power component e.g. comprising magnetic valve drivers and pump motor drivers. The power component in the capacity of an independent electronic modular unit can be separated from the modular unit with the microprocessor system. It is, however, likewise possible and preferred as an alternative that the power component along with the microprocessor system is integrated in an electronic modular unit.

The circuit arrangement of the invention will ensure among others that valve control or a brake booster function is safeguarded also after or during the existence of fluctuations in the supply voltage, in particular excess voltages of the voltage supply, to which the main relay establishes an electrical connection.

It can be suitable for up-to-date applications to design the circuit arrangement in such a fashion that it will not switch off in the event of a situation with supply voltage fluctuations. To comply with this requirement, provisions are made for a dynamically acting voltage limitation for the driver stages such as valve and booster drivers in particular. This voltage limitation is preferably designed in such a way that the other existing functionalities of the electronic control unit are not affected.

According to the invention, this objective is achieved in that the semiconductor main relay(s) already employed, which is (are) preferably configured as a high-side driver, in particular as a MOSFET transistor structure, is (are) not only used in switching operations but is (are) integrated in a voltage controller. The operating condition of the actuating circuit for the semiconductor main relay(s) is changed over in selected situations according to the invention. A selected situation is preferably encountered when the supply voltage of the circuit arrangement exceeds a determined fixed value, in particular for a determined prescribed time interval. In the controlled operation, the semiconductor main relay(s) is (are) preferably operated in such a fashion that, starting from a defined threshold value, the voltage on the load that is ‘switched’ by the semiconductor main relay or on the load drivers (e.g. valve and booster drivers), respectively, is limited (threshold-value-responsive voltage controller). To prevent the semiconductor main relay from being thermally destroyed, the linear control operation is preferably temporally limited. This is especially done because the switch-over phase is monitored by an additional timer, which is realized by software, for example.

Further preferred embodiments can be seen in the following description of the Figures.

Hereinbelow, the invention will be described in detail by way of the Figures.

### BRIEF DESCRIPTION OF THE DRAWINGS

In the accompanying drawings:

FIG. 1 is a block diagram for an exemplary circuit arrangement; and

FIG. 2 is an example for a more defined circuit arrangement for application in an electronic control unit of a motor vehicle brake system.

### DETAILED DESCRIPTION OF THE DRAWINGS

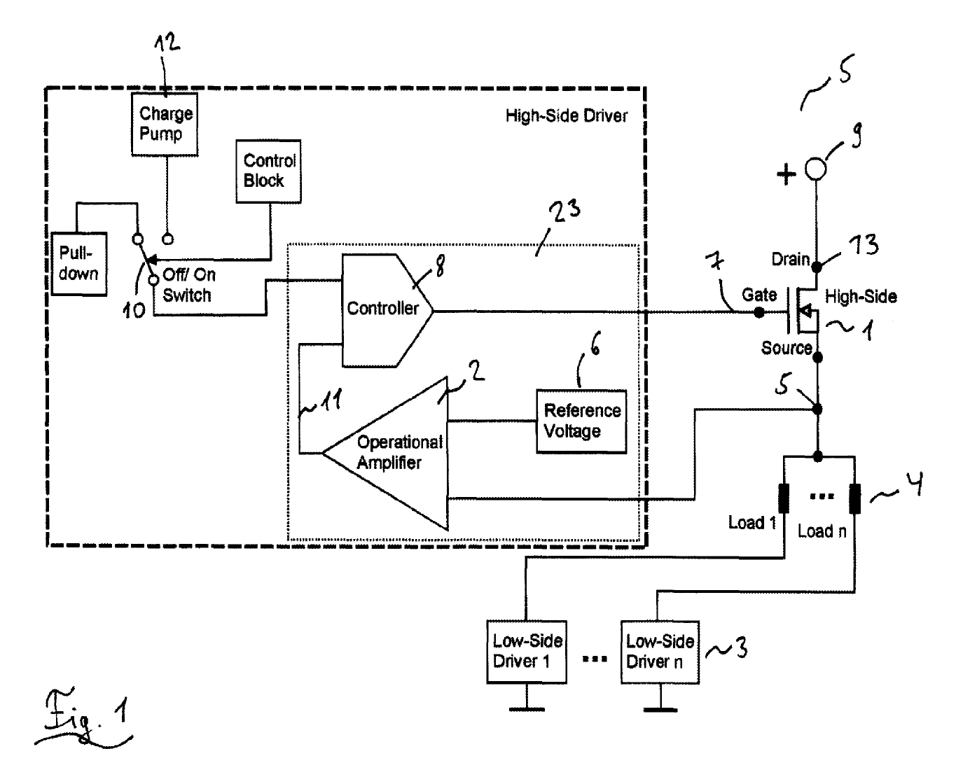

In FIG. 1, semiconductor main relay 1 is an N-channel MOSFET transistor, which is connected between supply voltage 9 and the loads 4, in this case valves and booster actuation control, driven by the low-side drivers 3. Semiconductor main relay 1 is driven by an actuating circuit 8, which will be explained in detail hereinbelow and is suitable for the adjustment of the resistance of semiconductor main relay 1. Switch 10 is connected to the input of actuating circuit 8, and the circuit's switch condition brings about a largely complete opening and closing of the semiconductor main relay 1, as is the case in conventional semiconductor relays as well. The present circuit is extended by a control loop consisting of operational amplifier 2, reference voltage source 6 and potential source 5 in such a manner that a controlling mode operation of the resistance of the high-side MOSFET 1 can be performed.

Suitably, the components actuating circuit 8, operational amplifier 2 and reference voltage source 6 can be integrated in one common modular unit 23.

The mode of functioning of actuating circuit 8 will be described in detail in the following. In normal operation, when there is no excess voltage or the like, N-channel MOSFET 1 is operated like a switch in the linear range by means of actuating circuit 8. For the voltage control during an excess voltage on the supply line, the N-channel MOSFET driven by the high-side driver is moved from the linear range into the saturation range. The potential at source-pin 5 of the semiconductor main relay 1 is monitored by way of line 7. When the voltage lies above a predetermined limit value, excess voltage is assumed, and the operating mode of the MOSFET 1 is changed from the switching operation into the linear operation. As long as the voltage at source-pin 5 lies below the reference voltage, operational amplifier 2 by way of line 11 produces a mass potential on control line 11 which is fed on the inlet side to actuating circuit 8. The signal on line 11 renders the actuating circuit 8 high-ohmic and the controller circuit inactive. When the voltage at source-pin 5 exceeds the reference voltage, a voltage which activates the controlling mode operation is set by way of line 11. The voltage causes a transistor in actuating circuit 8 to open, thus forming a path for draining the gate. As a result, the high-side MOSFET assumes the saturation mode and thereby reduces the voltage at the source-pin until it is equal to the excess voltage detection threshold value. A voltage drop at the source, e.g. provoked by a change of load, is controlled by actuation of the regulating transistor in such a fashion that finally the source potential corresponds to the detection threshold value again. MOSFET 1, which is operated in this manner, allows transforming the rate of power, which is supplied to the control unit on account of the excess voltage, into heat.

In the absence of excess voltage at terminal 9, the potential at source 5 of the transistor 1 drops and falls below the detection threshold value of operational amplifier 2. Thus, the circuit will leave the controlling mode operation and the voltage of the charge pump 12 is connected unmodified to gate 7 of high-side MOSFET 1.

The above circuit is additionally extended by a time measuring element disposed in the software of the controller electronics (not shown), which element allows determining the duration of the excess voltage. When the latter voltage exceeds a predetermined time of e.g. 500 ms, the software activates an additional independent protection circuit which completely disables the electronic control unit and can only be reset by activation of the vehicle's ignition.

It is preferably provided in addition to implement a device which allows disabling the voltage control function described above.

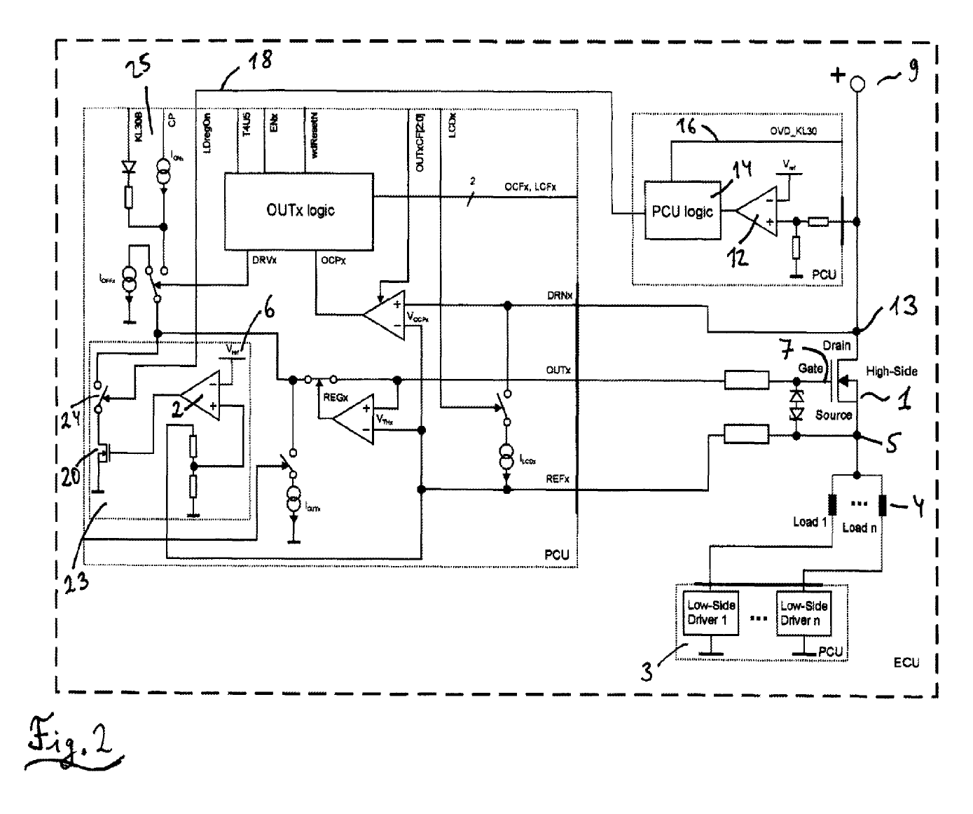

FIG. 2 shows an example of a circuit which principally acts corresponding to the circuit in FIG. 1 and, in addition, comprises further circuit elements being significant for the practical implementation. The circuit arrangement described herein additionally comprises another excess voltage detection comparator 12 which is connected to drain terminal 13 of semiconductor main relay 1. When the potential at terminal 13 exceeds a predefined potential, a signal is sent to logic 14.

Very short pulses of excess voltage (spikes) do not provoke a switch-over into the controlling mode operation in the circuit of FIG. 2. This is achieved by a delay in evaluation logic 14, in which case the output signal of comparator 12 which is connected to drain 13 will only be converted into a controlling mode activation signal 18 after lapse of a corresponding time. To this end, logic 14 comprises a timer which supplies the signal only upon lapse of a determined delay time of approximately 200 μs in order to activate the controlling mode operation by way of line 18 and to generate a flag which signals an active voltage control on line 16. Besides, the generated flag of the software serves as a start signal for a timer in order to finally switch off the control unit if the predetermined time of approximately 500 ms is exceeded.

A preliminary switch-off of the excess voltage detection protection and the leakage current detection current source is carried out at the same time as the activation of the voltage control. These functions are available again upon termination of the excess voltage.

A control bit in logic 14 permits disabling the entire control loop as well as the flag generation including the control signal generation. In this case, the circuit adopts an operating condition in which the voltage control of the invention is disabled. Activation/deactivation of the voltage control on source 5 takes place by selecting the two conditions of the evaluation logic 14. Depending on the condition chosen, the circuit reacts differently in the case of excess voltage at terminal 9. The basic setting causes system deactivation in the event of excess voltage, whereupon reactivation can occur only by means of the vehicle ignition. The second setting possibility activates the voltage control on MOSFET 1 during an excess voltage by closing switch 24.

In the example of a circuit according to FIG. 2, a regulating transistor 20 and an activation switch 24 corresponding to actuating circuit 8 assume the voltage control at the gate of the high-side MOSFET 1. In the case of control, the regulating transistor will decrease the voltage of charge pump 25 in such a way that MOSFET 1 reaches the saturation mode operation. Transistor 1 is in a fully conductive state during normal operation.

1-8. (canceled)

9. An electronic circuit (5) comprising:
one or more semiconductor main relays (1);
at least one semiconductor driver stage (3), wherein the one or more semiconductor main relay is connected to the at least one semiconductor driver stage (3) for actuation of loads (4), wherein when the semiconductor main relay (1) connects the loads and the at least one semiconductor driver to a voltage supply so that they can be disabled and the semiconductor main relays is operated as a voltage controller in selected situations and as a semiconductor switch in the other situations.

10. A circuit as claimed in claim 9, wherein a potential monitor (2, 6) is connected to a terminal (5) of the semiconductor main relay (1) associated with the load.

11. A circuit as claimed in claim 10, wherein an actuating line (7) of the semiconductor main relay is actuated by an actuating circuit (8) which is appropriate to set a resistance of the semiconductor main relay.

12. A circuit as claimed in claim 11, wherein an output of the potential monitor (2, 6) is connected to an input of the actuating circuit (8) to form a control loop.

13. A circuit as claimed in claim 10, wherein the potential monitor comprises an operational amplifier (2), which compares the potential of the load terminal (5) of the semiconductor main relay with a reference potential (6).

14. A circuit as claimed in claim 9, wherein a selected situation is given when the supply voltage of the circuit exceeds a determined fixed value.

15. A circuit as claimed in claim 9, wherein during the selected situation, an existing excess current detection which normally interrupts the current supply in a case of fault is deactivated during the controlling mode operation.

16. A circuit as claimed in claim 9, wherein the circuit is provided in a motor vehicle brake system such as a driving dynamics control system, a system for chassis control, or in an electronic actuation unit for vehicle safety systems.
